(19) United States
(12) Patent Application Publication
(10) Pub. No.: US 2015/0294612 A1
(43) Pub. Date: Oct. 15, 2015

(54) ORGANIC LIGHT-EMITTING DISPLAY PANEL AND ORGANIC LIGHT-EMITTING DISPLAY APPARATUS

(71) Applicant: Samsung Display Co., Ltd., Yongin-City (KR)

(72) Inventors: Dong-Gyu Kim, Yongin-City (KR); Yong-Jae Kim, Yongin-City (KR); Hae-Yeon Lee, Yongin-City (KR)

(21) Appl. No.: 14/511,131

(22) Filed: Oct. 9, 2014

(30) Foreign Application Priority Data
Apr. 9, 2014 (KR) 10-2014-0042534

(51) Int. Cl. G09G 3/20; G09G 3/32

(52) U.S. Cl. CPC G09G 3/2003; G09G 3/3208; G09G 2320/0233; G09G 2320/0242; G09G 2310/0289

(57) ABSTRACT

Provided is an organic light-emitting display panel including: a display area including a central display area and an edge display area; and a plurality of pixels arranged in a matrix form on the display area and configured to receive a first power voltage and a second power voltage having a voltage level that is lower than a voltage level of the first power voltage, wherein the voltage level of the first power voltage applied to the pixels in the central display area is higher than the voltage level of the first power voltage applied to the pixels in the edge display area, or the voltage level of the second power voltage applied to the pixels in the central display area is lower than the voltage level of the second power voltage applied to the pixels in the edge display area.

### CROSS-REFERENCE TO RELATED APPLICATION

This application claims priority to and the benefit of Korean Patent Application No. 10-2014-0042534, filed on Apr. 9, 2014 in the Korean Intellectual Property Office, the disclosure of which is incorporated herein in its entirety by reference.

### BACKGROUND

1. Field

Aspects of embodiments of the present invention relate to organic light-emitting display panels and organic light-emitting display apparatuses.

2. Description of the Related Art

An organic light-emitting display apparatus displays images by using organic light-emitting diodes (OLEDs) that generate light by recombination of electrons and holes. The organic light-emitting display apparatus has features of fast response speeds while operating at low power.

The organic light-emitting display apparatus includes a plurality of gate lines, a plurality of source lines, a plurality of power lines, and a plurality of pixels that are connected to the lines above and arranged in a matrix form. Brightness of the pixels of the organic light-emitting display apparatus driven in an analog manner is adjusted according to the size of input voltage data or input current data, to express a gradation. On the other hand, pixels of an organic light-emitting display apparatus driven in a digital manner emit light at the same brightness level, but express a gradation or gray level by controlling an emission time. Due to a relatively large current passing through the power lines, and resistance components of the power lines, a voltage drop (IR drop) may occur in the power lines, such that power voltages at different voltage levels are applied to the pixels, and thus, the pixels may not emit light at a desired brightness due to the different voltage levels. More particularly, in the organic light-emitting display apparatus driven in the digital manner, brightness variation caused by the IR drop of the power lines is very problematic.

### SUMMARY

Aspects of embodiments of the present invention relate to organic light-emitting display panels and organic light-emitting display apparatuses having reduced brightness variation caused by a voltage drop of power voltage lines.

Additional aspects will be set forth in part in the description which follows and, in part, will be apparent from the description of the embodiments of the present invention, or may be learned by practice of the embodiments of the present invention.

According an embodiment of the present invention, provided is an organic light-emitting display panel including: a display area including a central display area and an edge display area; and a plurality of pixels arranged in a matrix form on the display area and configured to receive a first power voltage and a second power voltage having a voltage level that is lower than a voltage level of the first power voltage, and the voltage level of the first power voltage applied to the pixels in the central display area is higher than the voltage level of the first power voltage applied to the pixels in the edge display area, or the voltage level of the second power voltage applied to the pixels in the central display area is lower than the voltage level of the second power voltage applied to the pixels in the edge display area.

The voltage level of the first power voltage applied to the pixels in the central display area may be higher than the voltage level of the first power voltage applied to the pixels in the edge display area, and the voltage level of the second power voltage applied to the pixels in the central display area may be higher than the voltage level of the second power voltage applied to the pixels in the edge display area.

The edge display area may include a top edge area near a top edge of the display area and a bottom edge area near a bottom edge of the display area, and the central display area may be between the top edge area and the bottom edge area.

The organic light-emitting display panel may further include: a plurality of power input lines that extend in a column direction on the display area and configured to receive the first power voltage; a plurality of connections in the central area of the display area and coupled to the plurality of power input lines; and a plurality of power output lines that extend in the column direction on the display area and coupled to the plurality of pixels and the plurality of connections, the plurality of power output lines being configured to output the first power voltage transmitted through the plurality of power input lines and the plurality of connections to the plurality of pixels.

The plurality of power input lines may include a first power input line, the plurality of connections may include at least one first connection coupled to the first power input line, the plurality of power output lines may include a first power output line coupled to the at least one first connection, and the pixels coupled to the first power output line may be configured to receive the first power voltage through the first power input line, the at least one first connection, and the first power output line.

The first power input line may be electrically coupled to the first power output line by the at least one first connection.

The at least one first connection may include a plurality of first connections and a number of the plurality of first connections may be between about 5% to about 30% of a number of rows of pixels.

The at least one first connection may include a plurality of first connections and a number of the plurality of first connections may be between about 5% to about 10% of a number of rows of pixels.

The plurality of connections may further include at least one second connection coupled to the first power input line, the plurality of power output lines may be coupled to the at least one second connection, and may further include a second power output line near the first power output line, and the pixels coupled to the second power output line may be configured to receive the first power voltage through the first power input line, the at least one second connection, and the second power output line.

The organic light-emitting display panel may further include at least one power wire outside of the display area, and configured to output the first power voltage to the plurality of power input lines.

Each of the plurality of power input lines may include a first end near a top edge of the display area and a second end near a bottom edge of the display area, and the at least one power wire may include a top power wire coupled to the first end of the plurality of power input lines and a bottom power wire coupled to the second end of the plurality of power input lines.

Each of the plurality of pixels may include a pixel circuit, and a light-emitting device having a first electrode coupled to the pixel circuit and a second electrode configured to receive the second power voltage.

The pixel circuit may include: a first thin film transistor configured to be turned on by a scan signal applied through a gate line, and to transmit a data signal applied through a source line; a second thin film transistor configured to be turned on according to a logic level of the data signal, and to transmit the first power voltage to the light-emitting device; and a capacitor configured to maintain the second thin film transistor in a turned on state or a turned off state according to the logic level of the data signal for a sub-field time duration.

The voltage level of the second power voltage applied to the pixels in the central display area may be lower than a voltage level of the second power voltage applied to the pixels in the edge display area, and the voltage level of the first power voltage applied to the pixels in the central display area may be lower than the voltage level of the first power voltage applied to the pixels in the edge display area.

According to another embodiment of the present invention, provided is an organic light-emitting display apparatus including: a power voltage generator configured to generate a first power voltage and a second power voltage having a voltage level that is lower than a voltage level of the first power voltage; and a display panel comprising a plurality of pixels configured to receive the first power voltage and the second power voltage and arranged in a matrix form on a display area, the display area comprising a central display area and an edge display area, and the voltage level of the first power voltage applied to the pixels in the central display area is higher than the voltage level of the first power voltage applied to the pixels in the edge display area, and the voltage level of the second power voltage applied to the pixels in the central display area is higher than the voltage level of the second power voltage applied to the pixels in the edge display area.

According to another embodiment of the present invention, provided is an organic light-emitting display panel including: a power input line that extends in a first direction on a display area and configured to receive a power voltage; a power output line that extends in the first direction on the display area; at least one connection that couples a central portion of the power output line to a central portion of the power input line; and a plurality of pixels on the display area, and the plurality of pixels coupled to the power output line are configured to receive the power voltage through the power input line, the at least one connection, and the power output line.

Current flowing through the power output line may flow from the central portion of the power output line coupled to the at least one connection towards ends of the power output line.

A voltage level of the power voltage supplied to the pixels coupled to the central portion of the power output line may be higher than the voltage level of the power voltage supplied to the pixels coupled to an end portion of the power output line.

The organic light-emitting display panel may further include a power wire configured to receive the power voltage, and to transmit the power voltage to the power input line that is directly coupled to the power wire, and the power wire may not be directly coupled to the power output line and may be electrically coupled to the power output line through the power input line and the at least one connection.

The plurality of pixels may include a plurality of sub-pixels, and power voltages having different voltage levels may be respectively applied to the plurality of sub-pixels.

### BRIEF DESCRIPTION OF THE DRAWINGS

These and/or other aspects will become apparent and more readily appreciated from the following description of the embodiments of the present invention, taken in conjunction with the accompanying drawings in which:

FIG. 1 is a block diagram of an organic light-emitting display apparatus according to an embodiment;

FIG. 2 is a circuit diagram of a pixel of an organic light-emitting display apparatus according to an embodiment;

FIG. 3 is a timing diagram of scan signals transmitted through gate lines of an organic light-emitting display apparatus according to an embodiment;

FIG. 4 schematically illustrates a portion of an organic light-emitting display panel according to a comparative example;

FIG. 5 is a graph showing voltage levels of a first power voltage and a second power voltage applied to pixels according to locations of the pixels of the organic light-emitting display panel of FIG. 4;

FIG. 6 schematically illustrates a portion of an organic light-emitting display panel according to an embodiment;

FIG. 7 is a graph showing voltage levels of a first power voltage and a second power voltage applied to pixels according to locations of the pixels of the organic light-emitting display panel of FIG. 6;

FIG. 8 schematically illustrates a portion of an organic light-emitting display panel according to another embodiment;

FIG. 9 is a graph showing voltage levels of a first power voltage and a second power voltage applied to pixels according to locations of the pixels of the organic light-emitting display panel of FIG. 8;

FIG. 10 schematically illustrates a portion of an organic light-emitting display panel according to another embodiment; and

FIG. 11 schematically illustrates a portion of an organic light-emitting display panel according to another embodiment.

### DETAILED DESCRIPTION

Reference will now be made in detail to embodiments of the present invention, examples of which are illustrated in the accompanying drawings, wherein like reference numerals refer to like elements throughout. In this regard, the embodiments of the present invention may have various different forms and should not be construed as being limited to the descriptions set forth herein. Accordingly, the embodiments are merely described below, by referring to the figures, to explain aspects of the present invention. As used herein, the term “and/or” includes any and all combinations of one or more of the associated listed. Expressions such as “at least one of,” when preceding a list of elements, modify the entire list of elements and do not modify the individual elements of the list.

As the present invention allows for various changes and numerous embodiments, example embodiments will be illustrated in the drawings and described in detail in the written description. Aspects and features of the present invention and methods of achieving the same will become clear with reference to the embodiments along with the drawings.

While such terms as “first”, “second”, etc., may be used to describe various components, such components should not be construed as limited to the above terms. The above terms are used only to distinguish one component from another. An expression used in the singular encompasses the expression of the plural, unless it has a clearly different meaning in the context. When an element is described as “coupled” or “connected” to another element, the element may be “directly coupled” or “directly connected” to the other element, or “indirectly coupled” or “indirectly connected” to the other element through one or more other intervening elements. In the present specification, it is to be understood that terms such as “including”, “having”, and “comprising” are intended to indicate the existence of the stated features, numbers, steps, actions, components, parts, or combinations thereof, and are not intended to preclude the possibility that one or more other features, numbers, steps, actions, components, parts, or combinations thereof may exist or may be added.

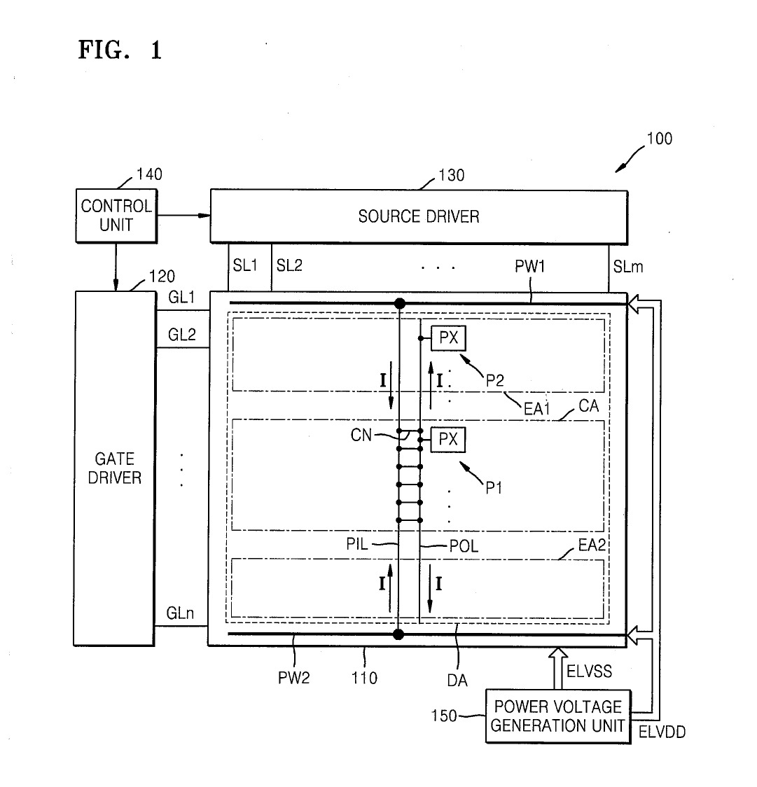

FIG. 1 is a block diagram of an organic light-emitting display apparatus according to an embodiment.

Referring to FIG. 1, the organic light-emitting display apparatus 100 includes a display panel 110, a gate driver 120, a source driver 130, a control unit 140 (e.g., a controller), and a power voltage generation unit 150 (e.g., a power voltage generator).

The display panel 110 includes a display area DA in which a plurality of pixels PX are arranged in a matrix form. A first power voltage ELVDD and a second power voltage ELVSS are applied to the pixels PX. A voltage level of the first power voltage ELVDD may be higher than a voltage level of the second power voltage ELVSS. For example, when the first power voltage ELVDD is applied to an anode of an organic light-emitting device and the second power voltage ELVSS is applied to a cathode of the organic light-emitting device, the organic light-emitting device emits light. The first power voltage ELVDD and the second power voltage ELVSS may be generated by the power voltage generation unit 150.

The display panel 110 includes first to n gate lines GL1-GLn (n is a positive integer) for applying gate signals to the pixels PX, and first to m source lines SL1-SLm (m is a positive integer) for applying source signals to the pixels PX. The display panel 110 includes a power wiring for applying the first power voltage ELVDD to the pixels PX. Each of the first to n gate lines GL1-GLn is respectively connected to each of the pixels PX aligned in a same row, and each of the source lines SL1-SLm is respectively connected to each of the pixels PX aligned in a same column. The pixels PX respond to gate signals transmitted through the first to n gate lines GL1-GLn, and emit light or do not emit light depending on logic levels of data signals transmitted through the source lines SL1-SLm. In this case, the display panel 110 may be driven in the digital manner. However, the present invention is not limited thereto, and according to another embodiment, the display panel 110 may be driven in an analog manner. In this case, the pixels PX may respond to the gate signals transmitted through the gate lines GL1-GLn, and emit light in response to the voltage level or the current level of the data signals transmitted through the source lines SL1-SLm. Hereinafter, embodiments of the present invention will be described based on an organic light-emitting display apparatus that is driven in the digital manner. However, the present invention is not limited thereto, and according to embodiments of the present invention the organic light-emitting display apparatus may be driven in an analog manner.

According to an embodiment, as illustrated in FIG. 1, the power wiring may include at least one of first and second power wires PW1 and PW2, to which the first power voltage ELVDD is supplied, a power input line PIL connected to the first and second power wires PW1 and PW2, at least one connection CN connected to the power input line PIL, and a power output line POL that is connected to the connection CN and the pixels PX, and via which the first power voltage ELVDD is supplied to the pixels PX.

The first and second power wires PW1 and PW2 may be disposed on an external surface of the display area DA, and the first power voltage ELVDD generated by the power voltage generation unit 150 may be directly supplied thereto. The first and second power wires PW1 and PW2 have low linear resistance compared with the power input line PIL and the power output line POL, and thus, a voltage drop according to flow of current may be negligibly small. FIG. 1 illustrates that the first power wire PW1 is disposed on a top of the display area DA and that the second power wire PW2 is disposed on a bottom of the display area DA. However, the present invention is not limited thereto, and depending on a design, the power wire PW may be disposed on a left side and/or a right side of the display area DA, the power wire PW may enclose the display area DA, or one of the first power wire PW1 and the second power wire PW2 may be omitted.

FIG. 1 illustrates one power input line PIL; however, a plurality of power input lines PIL may be disposed on the display panel 110, and the power input lines PIL may be connected to at least one of the first power wire PW1 or the second power wire PW2. As illustrated in FIG. 1, the power input lines PIL may be connected between the first power wire PW1 and the second power wire PW2. Each of the power input lines PIL may have a first end connected to the first power wire PW1 and a second end connected to the second power wire PW2. When one of the first power wire PW1 and the second power wire PW2 is omitted, the power input line PIL may be connected to the remaining one of the first power wire PW1 and the second power wire PW2. When the power wire PW is disposed on the left side and/or the right side of the display area DA, the power input line PIL may extend in a row direction (a horizontal direction in FIG. 1), and when the power wire PW encloses the display area DA, the power input lines PIL may be aligned in a mesh form.

FIG. 1 illustrates one power output line POL, but a plurality of power output lines POL may be aligned on the display panel 110 and be connected to the pixels PX. As illustrated in FIG. 1, the power output lines POL may extend in a column direction (a vertical direction in FIG. 1). However, the present invention is not limited thereto, and the power output lines POL may extend in the row direction or aligned in a mesh form. The power output line POL is disposed across the entire display area DA, and is connected to all of the pixels PX from a pixel PX in a first row of the display area DA to a pixel PX in a last row of the display area DA (n^{th} row in FIG. 1). However, the power output line POL is not directly connected to the first and second power wires PW1 and PW2.

The connections CN electrically connect the power input line PIL to the power output line POL. The connections CN may be connected to a central (e.g., middle) portion of the power output line POL. In the present specification, the central portion of the power output line POL refers to portions near a central point of the power output line POL in a length direction of the power output line POL. The number of connections CN connecting one power input line PIL and one power output line POL may be chosen between about 5% to about 30% of the number of rows of pixels PX (e.g., n in FIG. 1). According to another embodiment, the number of connections CN connected to one power output line POL may be chosen between about 5% to about 10% of the number of rows of pixels PX. If the number of connections CN is too small, the first power voltage ELVDD having a locally high voltage level may be applied to pixels PX near the connections CN, and thus, a bright line may be observed near the connections CN. If the number of connections CN is too large, problems related to reductions in voltage level of the first power voltage ELVDD supplied to the pixel PX located in the central portion of the display area DA may occur. However, the present invention is not limited thereto, and the power input line PIL and the power output line POL may be connected by one connection CN.

According to an embodiment illustrated in FIG. 1, the first power voltage ELVDD generated by the power voltage generation unit 150 may be supplied to the pixels PX via the first power wire PW1, the second power wire PW2, the power input lines PIL, the connections CN, and the power output lines POL. Accordingly, a current I flowing through the power output line POL may flow from the central portion connected to the connections CN to the end portion of the power output line POL. Since the power output line POL includes a resistant component, a voltage drop is generated due to the current I that flows along the power output line POL. Due to the voltage drop, the voltage level in the central portion of the power output line POL may be higher than the voltage level of the end portion of the power output line POL. As a result, the voltage level in the central portion of the power output line POL may be higher than the voltage level of the end portion of the power output line POL, and the voltage level of the first power voltage ELVDD supplied to the pixel PX located in the central portion in the display area DA may be higher than the voltage level of the first power voltage ELVDD supplied to the pixels PX located at an edge portion of the display area DA.

The second power voltage ELVSS generated by the power voltage generation unit 150 may be supplied to the pixels PX through a common electrode. The common electrode may correspond to one electrode of an organic light-emitting device of the pixels PX (for example, a cathode), and all of the pixels PX are connected to the common electrode. The common electrode may be formed to completely cover the pixels PX of the display area DA, and the second power voltage ELVSS may be supplied to the common electrode from an outer surface of the display area DA. The second power voltage ELVSS may have a voltage level that is lower than that of the first power voltage ELVDD, and thus, the current applied to the pixels PX may pass through the power voltage generation unit 150 via the common electrode. Accordingly, the voltage level of the outer portion of the common electrode, to which the second power voltage ELVSS is supplied, may be lower than the voltage level of the central portion of the common electrode. In other words, the current may flow from the central portion of the common electrode to the outer portion of the common electrode.

As in the case of the first power voltage ELVDD described with reference to the embodiment of FIG. 1, the second power voltage ELVSS may be supplied from the top and the bottom of the display area DA to the common electrode. However, the present invention is not limited thereto, and the second power voltage ELVSS may be supplied to the common electrode from at least one of the top, bottom, left, and right of the display area DA according to design.

As described above, according to the embodiment of FIG. 1, the voltage level of the first power voltage ELVDD supplied to the pixels PX located in the central portion of the display area DA may be higher than the voltage level of the first power voltage ELVDD supplied to the pixels PX located at an edge portion of the display area DA. Similarly, the voltage level of the second power voltage ELVSS supplied to the pixels PX located in the central portion of the display area DA may be higher than the voltage level of the second power voltage ELVSS supplied to the pixels PX located at the edge portion of the display area DA. Accordingly, differences in the voltage levels of the first power voltage ELVDD and the voltage levels of the second power voltage ELVSS supplied to the pixels PX in the display area DA becomes uniform or substantially uniform overall.

In contrast, if the voltage level of the first power voltage ELVDD supplied to the pixels PX located in the central portion of the display area DA is lower than the voltage level of the first power voltage ELVDD supplied to the edge portion of the display area DA, the difference in the voltage levels of the first power voltage ELVDD and the second power voltage ELVSS applied to the pixels PX located in the central portion of the display area DA may be substantially lower than the difference in the voltage levels of the first power voltage ELVDD and the second power voltage ELVSS supplied to the pixels PX located at the edge portion of the display area DA. Thus, differences between the voltage levels of the first power voltage ELVDD and the second power voltage ELVSS supplied to the pixels PX may increase. Accordingly, when all of the pixels PX in the display area DA emit light, the brightness of the central portion of the display area DA may be lower than the brightness of the edge portion of the display area DA.

In the present specification, the term “central portion” of the display area DA refers to an area in which the connections CN are disposed and adjacent areas. The central portion of the display area DA may be referred to as a central area CA. As described in the embodiment of FIG. 1, the central area CA may include an area including the middle portion between the top portion and the bottom portion of the display area DA. The central area CA may be different depending on an electrical pathway of the first power voltage ELVDD and/or the second power voltage ELVSS supplied to the pixels PX of the display area DA. For example, when the first power voltage ELVDD is supplied to the left side or the right side of the display area DA, the central area CA may be defined as an area including the left side and the right side of the display area DA. When the first power voltage ELVDD is supplied to four borders of the display area DA (e.g., surrounds the display area DA), the central area CA may be defined as an area including the central point of the display area DA and adjacent areas.

In the present specification, the edge portion of the display area DA may be defined according to the location where the first power voltage ELVDD and/or the second power voltage ELVSS are supplied to the display area DA. In the embodiment of FIG. 1, the first power voltage ELVDD is supplied to the display area DA through the first power wire PW1 and the second power wire PW2, which are respectively disposed on the top portion and the bottom portion of the display area DA, and thus, the edge portion of the display area DA may correspond to a top area and a bottom area of the display area DA. The edge portion of the display area DA may be referred to as an edge area, and the edge area may include a first edge area EA1 and a second edge area EA2, which together are referred to as an edge area EA. As illustrated in FIG. 1, the central area CA may be disposed between the first edge area EA1 and the second edge area EA2.

As illustrated in FIG. 1, a first pixel P1 is disposed in the central area CA of the display area DA, and a second pixel P2 is disposed in the edge area EA of the display area DA. As described above, the first power voltage ELVDD is supplied to the first pixel P1 and the second pixel P2 through the first power wire PW1, the second power wire PW2, the power input line PIL, the connections CN, and the power output line POL. In the power input line PIL, current I is applied from both ends of the power input line PIL to the central portion of the connections CN, and the current I may flow to the power output line POL through the connections CN. In the power output line POL, the current I flows from the central portion, in which the connections CN are disposed, to both ends of the power output line POL. The power output line POL includes resistant components, and thus, a voltage drop occurs due to the current I that flows along the power output line POL. Due to the voltage drop, a voltage level of the central portion of the power output line POL may be higher than a voltage level of the ends of the power output line POL. Accordingly, the voltage level of the first power voltage ELVDD supplied to the first pixel P1 may be higher than the voltage level of the first power voltage ELVDD supplied to the second pixel P2.

As described above, the organic light-emitting display apparatus 100 may be driven in the digital manner. The control unit 140 receives image data from outside, and controls the gate driver 120, the source driver 130, and the power voltage generation unit 150. The control unit 140 generates a plurality of control signals and digital data to provide the control signals to the gate driver 120, to provide the control signals and digital data to the source driver 130, and to provide the control signals to the power voltage generation unit 150.

The power voltage generation unit 150 may generate the first power voltage ELVDD and the second power voltage ELVSS, under the control of the control unit 140. The power voltage generation unit 150 provides the generated first power voltage ELVDD and the second power voltage ELVSS to the display panel 110.

The gate driver 120 drives the first to n gate lines GL1-GLn according to a sequence (e.g., a predetermined sequence) for each unit time in one frame, under the control of the control unit 140. For example, the first gate line GL1 is driven multiple times in one frame by using the gate driver 120. In other words, the gate driver 120 outputs scan signals multiple times through the first gate line GL1 during one frame.

The source driver 130 receives line data of m bits (m is a positive integer) from the control unit 140 for each time unit, and applies the line data of m bits to m number of source lines SL1-SLm, under the control of the control unit 140. For example, a data signal having a logic level corresponding to a logic level of a first bit in the line data of m bits may be provided to a first source line SL1. The data signal may have a low level or a high level, and a pixel PX that receives the data signal may or may not emit light depending on the logic level of the data signal.

In the present specification, descriptions are provided assuming that the pixel PX that received the data signal having a first logic level emits light and the pixel PX that receives the data signal having a second logic level does not emit light. Depending on a circuit design of the pixel PX, the first logic level may have a low level and the second logic level may have a high level, or the first logic level may have a high level and the second logic level may have a low level.

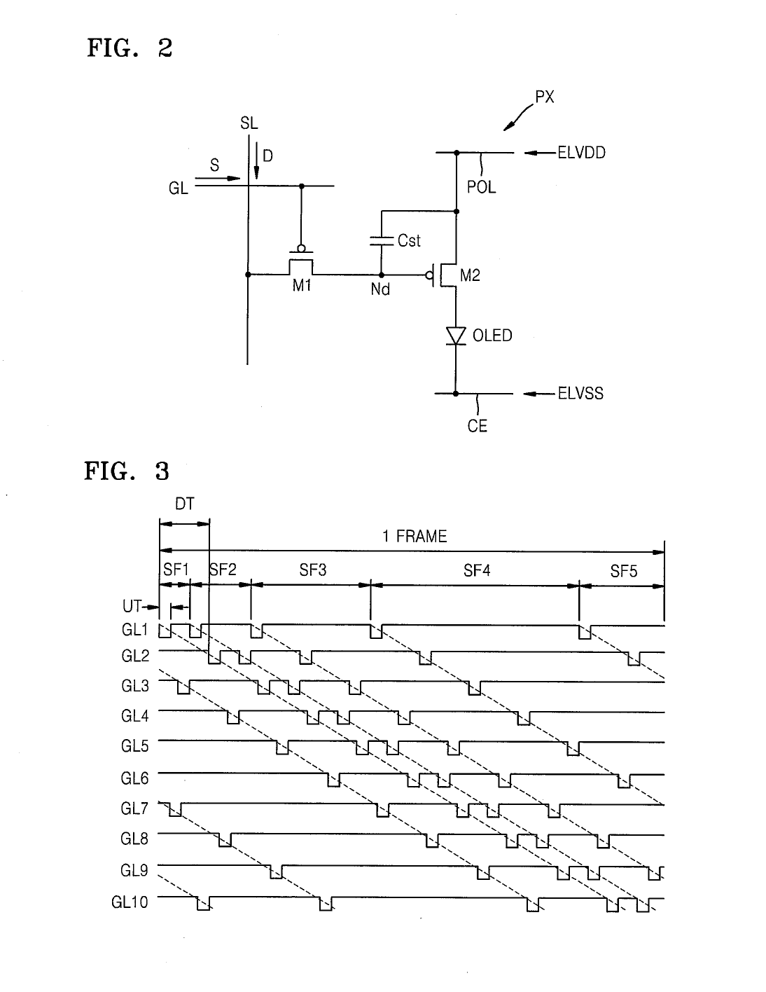

The pixel PX is described in detail with reference to FIG. 2.

FIG. 2 is a circuit diagram of a pixel PX in an organic light-emitting display, apparatus according to an embodiment.

Referring to FIG. 2, the pixel PX may be connected to a gate line GL of the same row as the pixel PX and a source line SL of the same column as the pixel PX. The pixel PX includes a pixel circuit and a light-emitting device. The pixel circuit includes a first transistor M1, a second transistor M2, and a storage capacitor Cst. The light-emitting device includes an organic light-emitting device OLED. The first transistor M1 and the second transistor M2 may be thin film transistors. The first transistor M1 includes a first connection terminal connected to the source line SL, a second connection terminal connected to a node Nd, and a control terminal connected to the gate line GL. The second transistor M2 includes a first connection terminal connected to a power output line POL, to which the first power voltage ELVDD is supplied, a control terminal connected to the node Nd, and a second connection terminal connected to a first electrode of the organic light-emitting device OLED. The storage capacitor Cst includes a first terminal connected to the first connection terminal of the second transistor M2, and a second terminal connected to the node Nd. The organic light-emitting device OLED includes the first electrode connected to the second connection terminal of the second transistor M2, and a second electrode connected to a common electrode CE, to which the second power voltage ELVSS is supplied. The first electrode and the second electrode may be an anode and a cathode, respectively, of the organic light-emitting device OLED.

The pixel PX receives a scan signal S through the gate line GL, and receives a data signal D through the source line SL. The first transistor M1 transmits the data signal D in response to the scan signal S, and inputs the data signal D to the control terminal of the second transistor M2. The second transistor M2 may be turned on or turned off according to the logic level of the transmitted data signal D, and when the second transistor M2 is turned on, the first power voltage ELVDD may be supplied to the first electrode of the organic light-emitting device OLED. The storage capacitor Cat maintains the second transistor M2 in the turned on state and the turned off state, according to the logic level of the data signal D during a subfield time period. For example, when the data signal D has the first logic level, the first power voltage ELVDD may be supplied to the first electrode of the organic light-emitting device OLED, and the organic light-emitting device OLED may emit light. When the digital data signal D has a second logic level, the second transistor M2 may be turned off, such that the first power voltage ELVDD is not supplied to the first electrode of the organic light-emitting device OLED, and thus, the organic light-emitting device OLED may not emit light.

The circuit design of the pixel PX illustrated in FIG. 2 is only one example, and thus, the pixel PX may have a different suitable circuit design.

The organic light-emitting display apparatus 100 that is driven in the digital manner will be described in detail with reference to FIG. 3.

FIG. 3 is a timing diagram of scan signals transmitted through first to tenth gate lines GL1-GL10 of the organic light-emitting display apparatus 100 according to an embodiment.

In the organic light-emitting display apparatus 100 that is driven in the digital manner, one frame includes a plurality of subfields, and a length of each subfield (for example, duration of display time) is determined according to a set weight.

As illustrated in FIG. 3, it is assumed that one frame includes 5 subfields, for example, a first subfield SF1 through a fifth subfield SF5. The pixels PX of the organic light-emitting display apparatus 100 may express a gradation (e.g., a gray level) through five-bit data, for example, first through fifth bit data. For example, a ratio of lengths of the first subfield SF1 to the fifth subfield SF5 may be 3:6:12:21:8. In other words, a ratio of display time durations of the first bit data through the fifth bit data may be, for example, 3:6:12:21:8.

For example, in one pixel PX connected to the first gate line GL1, a digital data signal having a level corresponding to a logic value of the first bit data at a scan timing, at which the first subfield SF1 begins, may be applied. The pixel PX may emit light or may not emit light during the first subfield SF1, depending on the logic value of the first bit data. As such, i bit data may be applied to the pixel PX at a scan timing when an i subfield SFi (in the present example, i is greater than or equal to 1 and less than or equal to 5) begins, and the pixel PX may emit light or may not emit light during the i subfield SFi depending on the logic value of the i bit data. In the description below, the fact that a digital data signal corresponding to a logic level of bit data is applied to the pixel PX may simply be expressed as the bit data is applied to the pixel PX.

The fifth subfield SF5 may be non-emission time. The fifth bit data may be inactive (or non-emission) bit data. For example, at a scan timing at which the fifth subfield SF5 begins, a digital signal having a second logic level may be applied to the pixel PX. In this case, the pixels PX may express a gradation (e.g., gray level) by using first through fourth bit data during one frame.

In the embodiment of FIG. 3, the number of gate lines GL1-GL10 is 10, and thus, one frame may include at least 10 delay times DT. Scan timings of the first to tenth gate lines GL1-GL10 may be delayed by a first delay time DT. For example, scan timings of (1+1) gate lines (GL(i+1)) may be delayed by 1 delay time DT of a scan timing of an i gate line GLi.

The first delay time DT may be a time divided into five unit times UT, such that only one gate line GL may be selected for each unit time UT. In other words, first delay time DT includes five unit times UT and one frame may include 50 unit times UT.

For example, as illustrated in FIG. 3, in the first delay time DT having the first through the fifth unit times UT, the first gate line GL1 may be selected for the first unit time UT, such that first bit data may be applied to a pixel PX connected to the first gate line GL1. In the second unit time UT, fourth bit data may be applied to a pixel PX connected to the seventh gate line GL7. In the third unit time UT, fifth bit data may be applied to a pixel PX connected to the third gate line GL3. In the fourth unit time UT, a second bit data may be applied to a pixel PX connected to the first gate line GL1. In the fifth unit time UT, third bit data may be applied to a pixel PX connected to the tenth gate line GL10.

The organic light-emitting display apparatus 100 illustrated in FIG. 1 includes m number of source lines SL1-SLm. In this case, in the first unit time UT, first line data of m bits, corresponding to the first bit data, may be applied to m number of pixels PX connected to the first gate line GL1 through the source lines SL1-SLm. In the second unit time UT, second line data of m bits, corresponding to fourth bit data, may be applied to m number of pixels connected to the seventh gate line GL7 through the source lines SL1-SLm. In the third unit time UT, third line data of m bits, corresponding to a fifth bit data, may be applied to m number of pixels connected to the third gate line GL3 through the source lines SL1-SLm. In the fourth unit time UT, fourth line data of m bits, corresponding to the second bit data, may be applied to m number of pixels connected to the first gate line GL1. In the fifth unit time UT, fifth line data of m bits, corresponding to the third bit data, may be applied to m number of pixels connected to the tenth gate line GL10.

Hereinafter, descriptions are provided for embodiments in which the first power voltage ELVDD is provided to the top portion and the bottom of the display area DA through a first power wire PW1 and a second power wire PW2 disposed at the top portion and the bottom portion of the display area DA, respectively, and the second power voltage ELVSS is supplied to the top and the bottom of the display area DA. However, the present invention may be applied in the same manner to other embodiments with different configurations.

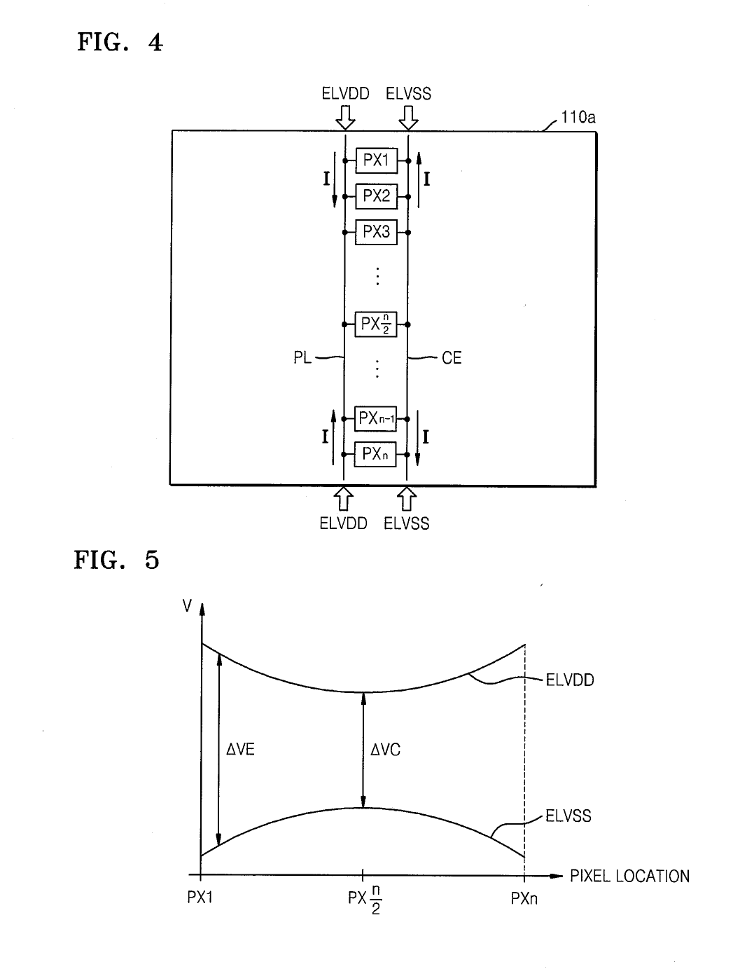

FIG. 4 schematically illustrates a portion of an organic light-emitting display panel according to a comparative example

Referring to FIG. 4, an organic light-emitting display panel 110a may include a plurality of pixels PX1-PXn, a power line PL for supplying the first power voltage ELVDD to the pixels PX1-PXn, and a common electrode CE for supplying the second power voltage ELVSS to the pixels PX1-PXn. The power line PL extends in a column direction and connects to the pixels PX1-PXn in the same column as the power line PL. The common electrode CE is shown as one line in FIG. 4, but is commonly connected to an organic light-emitting device of each of the pixels PX1-PXn.

The first power voltage ELVDD is applied to both ends of the power line PL, and the second power voltage ELVSS is applied to a top and a bottom of the common electrode CE. A current I consumed by the pixels PX1-PXn may flow into both ends of the power line PL, passes through the pixels PX1-PXn, and flows out of the top and the bottom of the common electrode CE. As described above, the power line PL has non-negligible resistance components, and thus, a voltage drop occurs due to the current I, in a direction of the flow of the current I. Since the common electrode CE also includes resistance components, a voltage drop occurs due to the current I, in the direction of the flow of the current I. For example, when the organic light-emitting display panel 110a is a top emission-type display panel, the common electrode CE may be formed as a transparent electrode or formed very thin, and thus, the common electrode CE has non-negligible resistance components.

FIG. 5 is a graph showing the voltage levels of the first power voltage ELVDD and the second power voltage ELVSS applied to the pixels PX according to locations of the pixels PX in the organic light-emitting display panel of FIG. 4.

Referring to FIG. 5, the first power voltage ELVDD may be supplied to the top and the bottom of the organic light-emitting display panel 110a. As a result, the voltage levels of the first power voltage ELVDD applied to a pixel in a first row PX1 and a pixel in a last row PXn are the highest, and the voltage level of the first power voltage ELVDD applied to the pixels PX2-PXn−1 gradually decreases towards the pixel in the middle row PXn/2. When all of the pixels PX1-PXn emit light, the voltage level of the first power voltage ELVDD applied to the pixel in the middle row PXn/2 may be the lowest.

Since the second power voltage ELVSS is supplied through the top and the bottom of the organic light-emitting display panel 110a, the voltage levels of the second power voltage ELVSS applied to the pixel in the first row PX1 and the pixel in the last row PXn are the lowest, and the voltage level of the second power voltage ELVSS applied to the pixels PX2-PXn−1 gradually increases towards the pixel in the middle row PXn/2.

Accordingly, a difference in the voltage levels ΔVE of the first power voltage ELVDD and the second power voltage ELVSS applied to the pixels PX1 and PXn, disposed at an edge area EA of the organic light-emitting display panel 110a, may be greater than a difference in the voltage levels ΔVC of the first power voltage ELVDD and the second power voltage ELVSS applied to the pixels (for example, PXn/2) disposed at a central area CA of the organic light-emitting display panel 110a. A difference between the differences in the voltage levels (for example, ΔVE−ΔVC) of the first power voltage ELVDD and the second power voltage ELVSS applied to the pixels PX1 to PXn includes a difference in voltage levels of the first power voltages ELVDD and a difference in voltage levels of the second power voltages ELVSS applied to the pixels PX1-PXn, and thus, the difference between the voltage levels increases more.

When the difference in the voltage levels of the first power voltage ELVDD and the second power voltage ELVSS applied to the pixels PX decreases by 1V, a current flowing through the pixels PX decreases by about 60%. When a size of the organic light-emitting display panel 110a increases, the voltage drop of the power line PL and the common electrode CE increases, and the brightness of the pixels located in the central area CA may decrease to a level that is less than half of the brightness of the pixels located at the edge area EA.

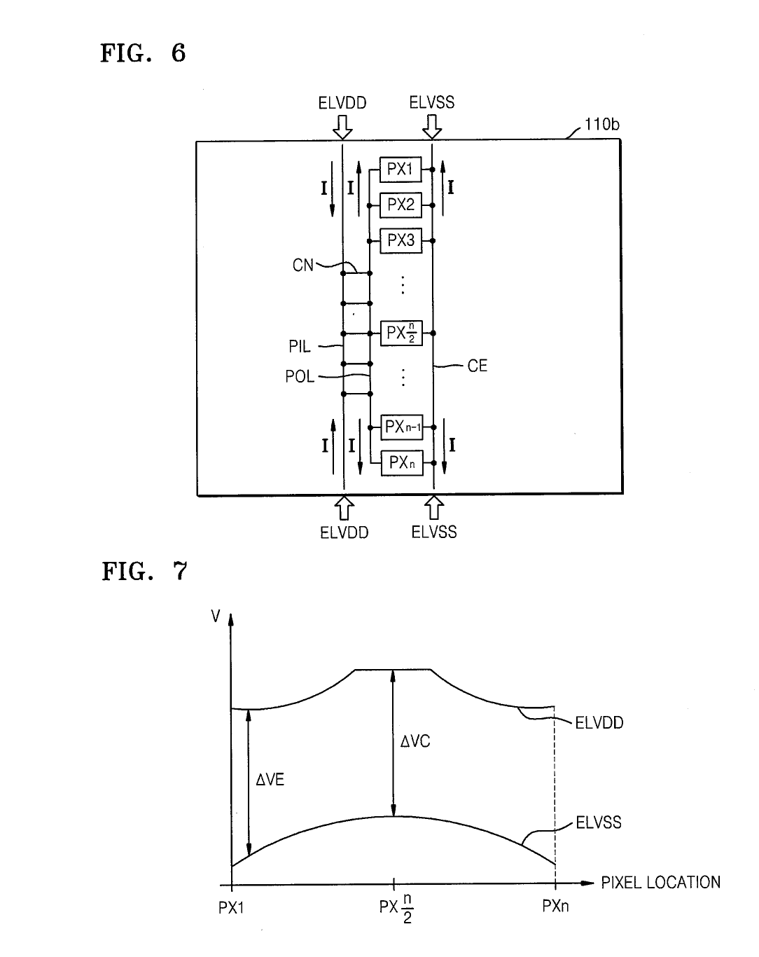

FIG. 6 schematically illustrates a portion of an organic light-emitting display panel 110b according to an embodiment.

Referring to FIG. 6, the organic light-emitting display panel 110b includes a plurality of pixels PX1-PXn, a power input line PIL for supplying a first power voltage ELVDD to the pixels PX1-PXn, connections CN, a power output line POL, and a common electrode CE for supplying the second power voltage ELVSS. The power input line PIL, the connections CN, and the power output line POL are described above with reference to FIG. 1, and thus, descriptions thereof are not repeated herein. The common electrode CE is described above with reference to FIG. 4, and thus, descriptions thereof are not repeated herein.

The first power voltage ELVDD may be applied through the top end and the bottom end of the power input line PIL, and the first power voltage ELVDD may be applied from the central portion of the power output line POL towards the top end and the bottom end through the connections CN. Accordingly, in the power output line POL, the current I flows from the central portion to both ends. Accordingly, a voltage drop occurs from the central portion to the ends of the power output line POL.

The second power voltage ELVSS may be applied to the top and the bottom of the common electrode CE. The common electrode CE also includes resistance components, and thus, a voltage drop occurs due to the current I in a direction of flow of the current I.

FIG. 7 is a graph showing voltage levels of a first power voltage ELVDD and a second power voltage ELVSS applied to pixels PX according to locations of the pixels PX in the organic light-emitting display panel of FIG. 6.

Referring to FIG. 7, a voltage drop occurs when the first power voltage ELVDD is applied from the central portion to both ends of the power output line POL. The voltage level of the first power voltage ELVDD applied to the pixels PX (for example, pixel (PXn/2)) located in the central portion is the highest, and the voltage level of the first power voltage ELVDD applied to the pixels decreases from the pixels PX located in the central portion to the pixel in the first row PX1 and the pixel in the last row PXn. When the power input line PIL and the power output line POL are connected by many connections CN, the voltage levels of the first power voltage ELVDD applied to the pixels PX near the first connection CN and the last connection CN are the highest, and the voltage level of the first power voltage ELVDD applied to the pixel (PXn/2) located in the middle may be lower than those.

Since the second power voltage ELVSS is supplied from the top and the bottom of the organic light-emitting display panel 110b, the voltage levels of the second power voltage ELVSS applied to the pixel in the first row PX1 and the pixel in the last row PXn are the lowest, and the voltage level of the second power voltage ELVSS applied to the pixels PX2-PXn−1 gradually increases towards the pixel in the middle row PXn/2.

Accordingly, as illustrated in FIG. 7, changes in the voltage level of the first power voltage ELVDD and the voltage level of the second power voltage ELVSS applied to the pixels PX of the organic light-emitting display panel 110b may have similar characteristics. In other words, the difference in the voltage levels (ΔVE) of the first power voltage ELVDD and the second power voltage ELVSS applied to the pixels (for example, PX1 and PXn) located at the edge area EA of the organic light-emitting display panel 110b may be similar to or substantially the same as the difference in the voltage levels (ΔVC) of the first power voltage ELVDD and the second power voltage ELVSS applied to the pixels (for example, PXn/2) located at or near the central area CA of the organic light-emitting display panel 110b. The difference in the voltage levels of the second power voltage ELVSS applied to the pixels PX1-PXn are compensated for by the difference in the voltage levels of the first power voltage ELVDD applied to the pixels PX1-PXn, and thus, the differences in the voltage levels of the first power voltage ELVDD and the second power voltage ELVSS applied to the pixels PX1-PXn may be reduced. Accordingly, the brightness uniformity of the pixels PX1-PXn may be improved.

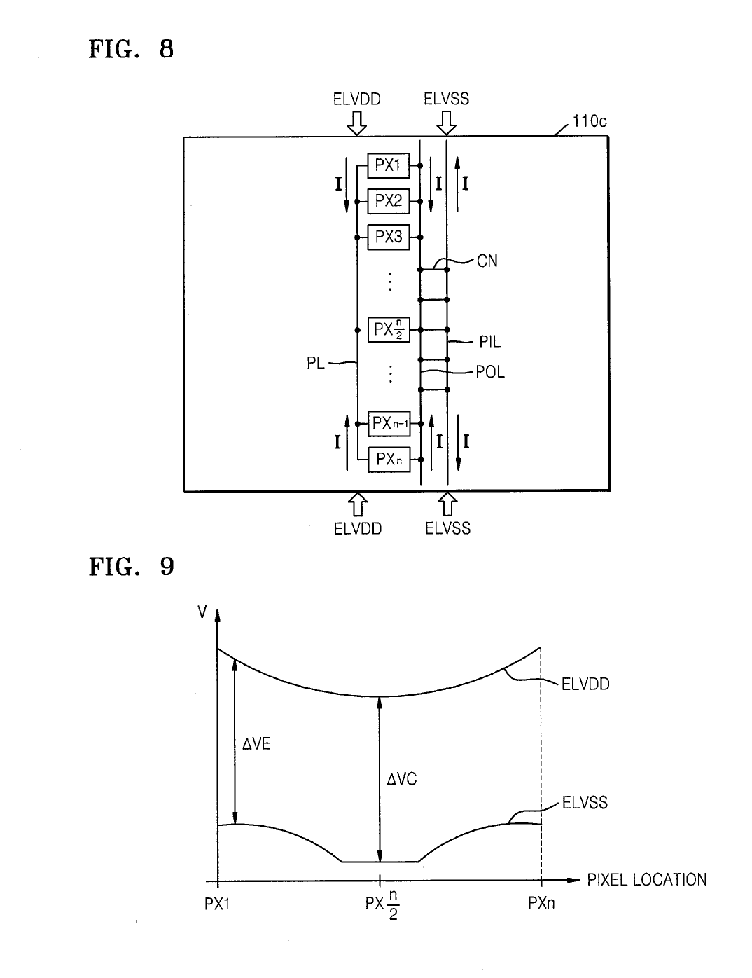

FIG. 8 schematically illustrates a portion of an organic light-emitting display panel 110c according to another embodiment.

Referring to FIG. 8, the organic light-emitting display panel 110c may include a plurality of pixels PX1-PXn, a power line PL for supplying a first power voltage ELVDD, a power input line PIL for supplying a second power voltage ELVSS to the pixels PX1-PXn, connections CN, and a power output line POL. The power line PL is described above with reference to FIG. 4, and thus, descriptions thereof are not repeated. The power input line PIL, the connections CN, and the power output line POL are described above with reference to FIG. 1, and thus, detailed descriptions thereof are not repeated. In the embodiment of FIG. 8, however, the power input line PIL, the connections CN, and the power output line POL may be disposed on the common electrode CE, or may supply the second power voltage ELVSS to the pixels PX without the common electrode CE.

The first power voltage ELVDD may be applied to the top end and the bottom end of the power line PL. The current I consumed by the pixels PX1-PXn may be flowed from the top portion and the bottom portion of the power line PL. A voltage drop may occur in the power line PL in a direction of the flow of the current I.

The second power voltage ELVSS may be applied to the top end and the bottom end of the power input line PIL, and the second power voltage ELVSS may be supplied from the central portion towards the top end and the bottom end of the power output line POL through the connections CN. Accordingly, in the power output line POL, the current I flows from both ends to the central portion thereof. Accordingly, a voltage drop occurs at both ends of the power output line POL towards the central portion.

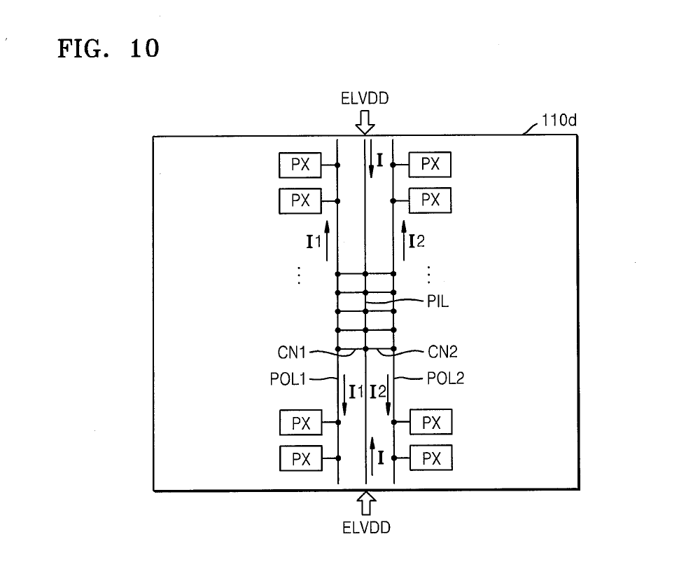

FIG. 9 is a graph showing voltage levels of a first power voltage ELVDD and a second power voltage ELVSS applied to pixels PX according to locations of the pixels PX in the organic light-emitting display panel 110c of FIG. 8.

Referring to FIG. 9, the first power voltage ELVDD undergoes a voltage drop from both ends of the power line PL to the central portion, and thus, the voltage level of the first power voltage ELVDD applied to the pixels located at both ends PX1 and PXn are the highest, and the voltage level of the first power voltage ELVDD applied to the pixels PX2-PXn−1 gradually decreases towards the central portion of the power line PL.

The second power voltage ELVSS undergoes a voltage drop from both ends of the power output line POL to the central portion of the power output line POL, and thus, the voltage level of the second power voltage ELVSS applied to the pixels located at both ends PX1 and PXn are the highest, and the voltage level of the second power voltage ELVSS applied to the pixels PX2-PXn−1 gradually decreases towards the central portion of the power output line POL.

Accordingly, as illustrated in FIG. 9, changes in the voltage level of the first power voltage ELVDD and changes in the voltage level of the second power voltage ELVSS applied to the pixels PX of the organic light-emitting display panel 110c may have similar characteristics. In other words, the difference in the voltage levels (ΔVE) of the first power voltage ELVDD and the second power voltage ELVSS applied to the pixels (for example, PX1 and PXn) located at the edge area EA of the display panel 110c may be similar to the difference in the voltage levels (ΔVC) of the first power voltage ELVDD and the second power voltage ELVSS applied to the pixels (for example, PXn/2) at or near the central area CA of the organic light-emitting display panel 110c. The difference in the second power voltage ELVSS applied to the pixels PX1-PXn is compensated for by the difference in the voltage level of the first power voltage ELVDD applied to the pixels PX1-PXn, and thus, the difference in the voltage levels of the first power voltage ELVDD and the second power voltage ELVSS applied to the pixels PX1-PXn may be reduced. Accordingly, the brightness uniformity of the pixels PX1-PXn may be improved.

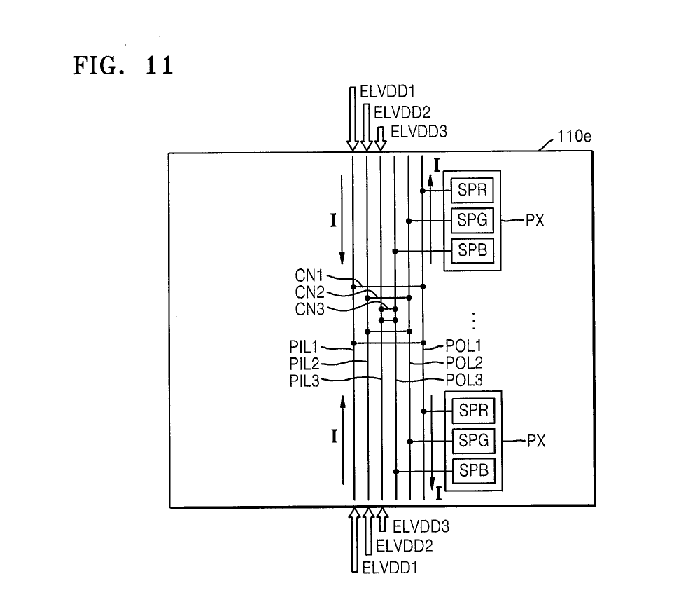

FIG. 10 schematically illustrates a portion of an organic light-emitting display panel 110d according to another embodiment.

Referring to FIG. 10, the organic light-emitting display panel 110d may include a power input line PIL, a first connection CN1 and a second connection CN2 connected to the power input line PIL, and a first power output line POL1 connected to the first connection CN1 and a second power output line POL2 connected to the second connection CN2, to apply the first power voltage ELVDD to the pixels PX. The organic light-emitting display panel 110d may include pixels PX connected to the first power output line POL1 and pixels PX connected to the second power output line POL2. The common electrode CE that supplies the second power voltage ELVSS may be connected to the pixels PX.

The first connection CN1 may be connected to a central portion of the first power output line POL1 and the second connection CN2 may be connected to a central portion of the second power output line POL2. A first current I1 consumed by the pixels PX connected to the first power output line POL1, and a second current I2 consumed by the pixels PX connected to the second power output line POL2, may both be supplied by the power input line PIL.

Also, in the organic light-emitting display panel 110d of the embodiment shown in FIG. 10, the voltage level of the first power voltage ELVDD applied to the pixels PX located in the central portion of the display area DA may be higher than the voltage level of the first power voltage ELVDD applied to the pixels PX located at the edge portion of the display area DA, as shown in FIG. 7. When the second power voltage ELVSS is supplied to top and bottom of the display panel 110d through the common electrode CE, the brightness uniformity of the organic light-emitting display panel 110d may be improved. Also, according to the embodiment of FIG. 10, the number of power lines PL that supply the first power voltage ELVDD may be reduced, and thus, an aperture ratio of the pixels PX may increase.

FIG. 11 schematically illustrates a portion of an organic light-emitting display panel 110e according to another embodiment.

Referring to FIG. 11, in the organic light-emitting display panel 110e, at least one of the pixels PX may include first through third sub-pixels (SPR, SPG, and SPB). The first sub-pixel SPR may emit red light, the second sub-pixel SPG may emit green light, and the third sub-pixel SPB may emit blue light. The pixels PX may each further include a sub-pixel for emitting white light.

A first power voltage ELVDD1 may be applied to the first sub-pixels SPR through a first power input line PIL1, a first connection CN1 connected to the first power input line PIL1, and a first power output line POL1 connected to the first connection CN1. A second power voltage ELVDD2 may be applied to the second sub-pixels SPG through a second power input line PIL2, a second connection CN2 connected to the second power input line PIL2, and a second power output line POL2 connected to the second connection CN2. A third power voltage ELVDD3 may be applied to the third sub-pixels SPB through a third power input line PIL3, a third connection CN3 connected to the third power input line PIL3, and a third power output line POL3 connected to the third connection CN3. The first through third power voltages ELVDD1-ELVDD3 may have different voltage levels. For example, the voltage level of the first power voltage ELVDD1 may be the highest and the voltage level of the third power voltage ELVDD3 may be the lowest.

The first through third connections CN1-CN3 may be connected to central portions of the first through third power output lines POL1-POL3. A current flowing through the first through third power output lines POL1-POL3 may flow from the central portion to both ends of the power output lines POL. Also, in the organic light-emitting display panel 110e illustrated in FIG. 11, the voltage level of the first through third power voltages ELVDD1-ELVDD3 applied to the first through third sub-pixels SPR, SPG, and SPB located in the central portion of the display area DA may be higher than the voltage level of the first through third power voltages ELVDD1-ELVDD3 of the first through third sub-pixels SPR, SPG, and SPB located at the edge portion of the display area DA, as illustrated in the graph of FIG. 7. When the second power voltage ELVSS is supplied to the common electrode CE from the top and the bottom of the organic light-emitting display panel 110e, the brightness uniformity of the organic light-emitting display panel 110e may be improved.

As described above, according to aspects of embodiments of the present invention, as the difference in voltage levels of a first power voltage and a second power voltage applied to pixels of an organic light-emitting display apparatus decreases, brightness variation of the pixels decreases. Accordingly, the definition of images displayed by the organic light-emitting display apparatus according to various embodiments of the present invention may be improved.

It should be understood that the example embodiments described herein should be considered in a descriptive sense only and not for purposes of limitation. Descriptions of features or aspects within each embodiment should typically be considered as available for other similar features or aspects in other embodiments.

While embodiments of the present invention have been described with reference to the figures, it will be understood by those of ordinary skill in the art that various changes in form and details may be made thereto, without departing from the spirit and scope of the present invention as defined by the following claims, and their equivalents.

What is claimed is:

1. An organic light-emitting display panel comprising:
a display area comprising a central display area and an edge display area; and
a plurality of pixels arranged in a matrix form on the display area and configured to receive a first power voltage and a second power voltage having a voltage level that is lower than a voltage level of the first power voltage, wherein
the voltage level of the first power voltage applied to the pixels in the central display area is higher than the voltage level of the first power voltage applied to the pixels in the edge display area, or
the voltage level of the second power voltage applied to the pixels in the central display area is lower than the voltage level of the second power voltage applied to the pixels in the edge display area.

2. The organic light-emitting display panel of claim 1, wherein the voltage level of the first power voltage applied to the pixels in the central display area is higher than the voltage level of the first power voltage applied to the pixels in the edge display area, and
the voltage level of the second power voltage applied to the pixels in the central display area is higher than the voltage level of the second power voltage applied to the pixels in the edge display area.

3. The organic light-emitting display panel of claim 1, wherein the edge display area comprises a top edge area near a top edge of the display area and a bottom edge area near a bottom edge of the display area, and
the central display area is between the top edge area and the bottom edge area.

4. The organic light-emitting display panel of claim 1, further comprising:
a plurality of power input lines that extend in a column direction on the display area and configured to receive the first power voltage;
a plurality of connections in the central area of the display area and coupled to the plurality of power input lines; and
a plurality of power output lines that extend in the column direction on the display area and coupled to the plurality of pixels and the plurality of connections, the plurality of power output lines being configured to output the first power voltage transmitted through the plurality of power input lines and the plurality of connections to the plurality of pixels.

5. The organic light-emitting display panel of claim 4, wherein
the plurality of power input lines comprises a first power input line,
the plurality of connections comprises at least one first connection coupled to the first power input line,
the plurality of power output lines comprises a first power output line coupled to the at least one first connection, and
the pixels coupled to the first power output line are configured to receive the first power voltage through the first power input line, the at least one first connection, and the first power output line.

6. The organic light-emitting display panel of claim 5, wherein the first power input line is electrically coupled to the first power output line by the at least one first connection.

7. The organic light-emitting display panel of claim 6, wherein the at least one first connection comprises a plurality of first connections and a number of the plurality of first connections is between about 5% to about 30% of a number of rows of pixels.

8. The organic light-emitting display panel of claim 6, wherein the at least one first connection comprises a plurality of first connections and a number of the plurality of first connections is between about 5% to about 10% of a number of rows of pixels.

9. The organic light-emitting display panel of claim 5, wherein the plurality of connections further comprises at least one second connection coupled to the first power input line,
the plurality of power output lines are coupled to the at least one second connection, and further comprises a second power output line near the first power output line, and
the pixels coupled to the second power output line are configured to receive the first power voltage through the first power input line, the at least one second connection, and the second power output line.

10. The organic light-emitting display panel of claim 4, further comprising at least one power wire outside of the display area, and configured to output the first power voltage to the plurality of power input lines.

11. The organic light-emitting display panel of claim 10, wherein each of the plurality of power input lines comprises a first end near a top edge of the display area and a second end near a bottom edge of the display area, and
the at least one power wire comprises a top power wire coupled to the first end of the plurality of power input lines and a bottom power wire coupled to the second end of the plurality of power input lines.

12. The organic light-emitting display panel of claim 1, wherein each of the plurality of pixels comprises a pixel circuit, and a light-emitting device comprising a first electrode coupled to the pixel circuit and a second electrode configured to receive the second power voltage.

13. The organic light-emitting display panel of claim 12, wherein the pixel circuit comprises:
a first thin film transistor configured to be turned on by a scan signal applied through a gate line, and to transmit a data signal applied through a source line;
a second thin film transistor configured to be turned on according to a logic level of the data signal, and to transmit the first power voltage to the light-emitting device; and
a capacitor configured to maintain the second thin film transistor in a turned on state or a turned off state according to the logic level of the data signal for a sub-field time duration.

14. The organic light-emitting display panel of claim 1, wherein
the voltage level of the second power voltage applied to the pixels in the central display area is lower than a voltage level of the second power voltage applied to the pixels in the edge display area, and
the voltage level of the first power voltage applied to the pixels in the central display area is lower than the voltage level of the first power voltage applied to the pixels in the edge display area.

15. An organic light-emitting display apparatus comprising:
a power voltage generator configured to generate a first power voltage and a second power voltage having a voltage level that is lower than a voltage level of the first power voltage; and
a display panel comprising a plurality of pixels configured to receive the first power voltage and the second power voltage and arranged in a matrix form on a display area, the display area comprising a central display area and an edge display area, wherein
the voltage level of the first power voltage applied to the pixels in the central display area is higher than the voltage level of the first power voltage applied to the pixels in the edge display area, and
the voltage level of the second power voltage applied to the pixels in the central display area is higher than the voltage level of the second power voltage applied to the pixels in the edge display area.

16. An organic light-emitting display panel comprising:
a power input line that extends in a first direction on a display area and configured to receive a power voltage;
a power output line that extends in the first direction on the display area;
at least one connection that couples a central portion of the power output line to a central portion of the power input line; and
a plurality of pixels on the display area, wherein the plurality of pixels coupled to the power output line are configured to receive the power voltage through the power input line, the at least one connection, and the power output line.

17. The organic light-emitting display panel of claim 16, wherein current flowing through the power output line flows from the central portion of the power output line coupled to the at least one connection towards ends of the power output line.

18. The organic light-emitting display panel of claim 16, wherein a voltage level of the power voltage supplied to the pixels coupled to the central portion of the power output line is higher than the voltage level of the power voltage supplied to the pixels coupled to an end portion of the power output line.

19. The organic light-emitting display panel of claim 16, further comprising a power wire configured to receive the power voltage, and to transmit the power voltage to the power input line that is directly coupled to the power wire, wherein
the power wire is not directly coupled to the power output line and is electrically coupled to the power output line through the power input line and the at least one connection.

20. The organic light-emitting display panel of claim 16, wherein the plurality of pixels comprises a plurality of sub-pixels, and wherein power voltages having different voltage levels are respectively applied to the plurality of sub-pixels.
